(19) United States
(12) Patent Application Publication
(10) Pub. No.: US 2009/0265791 A1
(43) Pub. Date: Oct. 22, 2009

(54) METHOD A SYSTEM AND A UNIT FOR CONTROLLING LISTING OF ITEMS ON ELECTRONIC MARKET DATABASES

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/104,262

(22) Filed: Apr. 16, 2008

(51) Int. Cl. H04L 9/32

(52) U.S. Cl. 726/28

(57) ABSTRACT

There is provided a method a method for controlling listing of a given item on an electronic market database, the method comprising (1) receiving a listing request originated from a prospective provider for listing said given item on said electronic market database; (2) authenticating at least one of said given item and of said prospective provider; and (3) if a successful authentication, listing said given item on said electronic database. There is further provided a system as well as a unit for controlling listing of a given item on an electronic market database.

### FIELD OF THE INVENTION

This description relates to the field of electronic commerce. More precisely, this invention pertains to a method and system for controlling listing of items on electronic market databases.

### BACKGROUND OF THE INVENTION

Counterfeit products are a global phenomenon that is deeply hurting brand name manufacturers and sometimes posing serious dangers to the public. Counterfeit products are also hurting worldwide economies from the many jobs being lost and in the loss of government tax revenues. Also, the sales of fake goods often help to finance other criminal activities such as drugs, human trafficking, prostitution, and terrorism. There is no limit to the scope of product counterfeiting. These fake products may range, for example, from well known brand name fashion items, pharmaceutical products, and electronic items. Alarmingly, in the past few years, counterfeiters have expanded their product horizons and almost any viable product is being counterfeited.

Asia is one of the regions where most of the counterfeit goods are being produced. The problem also lies within western countries where counterfeits are also being manufactured in some instances.

As the electronic commerce evolves, the Internet has made it easier for counterfeit products to be sold internationally. It has reached such a proportion that it is endangering the global economy. It has even back fired at high profile Internet companies. For example, eBay is in the process of being sued by numerous brand name companies over allegations of intellectual propriety infringement. These manufacturers feel that aggregator web-sites, i.e. websites such as eBay, encourage the sale of counterfeit products and are benefiting from the sales of fake goods since they receive a commission on each item sold. They also feel that eBay is largely responsible for fake goods sold on its site and that it is eBay's obligation to reduce fake products listed on its web-site. For now, eBay and all other aggregator sites do not offer any technological manner to protect the authenticity of a product. The manufacturers must hire a workforce of investigators to search for fake products listed on aggregator sites which exist on the internet. They must then deal with the aggregator sites to stop the selling of these fake goods or contact the local authority and report the counterfeit seller's web site.

Furthermore, buyers who wish to purchase a product on-line or off-line do not have any manner of protecting themselves from purchasing counterfeit goods. They must rely on the reputation of the seller and common sense.

Investigators, i.e. police forces, have no technological manner of investigating the authenticity of products sold on-line or off-line. They must wait for a complaint to be filed in order to begin the investigation.

### SUMMARY OF THE INVENTION

It is therefore an object of the present invention to provide a method and system for controlling listing of items on electronic market databases that overcome the above drawbacks.

As a first aspect of the invention there is provided a method for controlling listing of a given item on an electronic market database, the method comprising:
receiving a listing request originated from a prospective provider for listing the given item on the electronic market database;
authenticating at least one of the given item and of the prospective provider; and
if a successful authentication, listing the given item on the electronic database.

Preferably, the authentication of the given item comprises verifying if the given item is counterfeited or stolen and the authenticating the prospective provider comprises verifying if the prospective provider is an authorized provider of the given item.

Preferably The authenticating process comprises transmitting an authentication request for inquiring an authentication database comprising, for each one of a plurality of items, an identifier for uniquely identifying the item and at least one corresponding authorized item provider, the authentication request comprising an identification of the given item and an identification of the prospective provider, the method further comprising providing an indication of a successful authentication if the identification of the given item and the identification of the prospective provider are comprised in the authentication database, otherwise providing an indication of an unsuccessful authentication.

The method preferably further comprises, if an unsuccessful authentication, refusing to list the given item on the electronic database.

The method preferably further comprises, if an unsuccessful authentication, tagging the given item as unsuccessfully authenticated and listing the tagged given item on the electronic database.

The method preferably further comprises, if an unsuccessful authentication, communicating with a third party trusted source for verifying if the prospective provider is an unregistered authorized provider of the given item, and listing the given item on the electronic database if a positive confirmation is received thereof.

The third party trusted source could be the manufacturer, an authorized reseller of the manufacturer or an investigator and in this case the communication process comprises transmitting an inquiring request to the third party trusted source with an indication of the given item and of the prospective provider.

The inquiring request transmitted to the third party trusted source could be triggered manually by a user or automatically upon reception of an unsuccessful authentication.

The third party trusted source could also be an authorized item provider registered in the authentication database in association with the given item, and in this case, the communication process comprises transmitting an inquiring request to the registered authorized provider with an indication of the given item and of the prospective provider.

The inquiring request transmitted to the registered authorized item provider could be triggered manually by a user or automatically upon reception of an unsuccessful authentication.

The verifying if the prospective provider is an unregistered authorized provider of the given item could be verifying if an ownership transfer from the registered authorized item provider to the prospective provider has been carried out in association with the given items.

The method preferably further comprises updating the authentication database to reflect the ownership transfer if a positive confirmation is received.

Preferably, the communication with the authentication database is performed through the Internet, SMS, telephone or mobile phone, or paper documents.

Preferably, the method is principally carried out over a data network, and the data network comprises at least one of the Internet and a mobile phone network.

Preferably, the method is principally carried out by a mediator using a mediator server connected to the data network.

The electronic market database could be locally connected to the mediator server or could be remotely connected to the mediator server through the data network.

As another aspect of the invention, there is provided a unit for controlling listing of a given item on an electronic market database, the unit comprising an input/output unit, a processing unit and a listing criteria database, where the input/output unit receives authentication data in connection with at least one of the given item and of a prospective provider of the given item and transmits the authentication data to the processing unit, where the processing unit processes the authentication data as a function of defined listing criteria stored in the listing criteria database and generates a control signal as a function of the processing.

Preferably, the control signal is selected from the group consisting of an indication to allow listing the given item, an indication to refuse listing the given item, an indication to tag the given item as unsuccessfully authenticating and to allow listing the tagged item, and an indication to communicate with a third party trusted source for verifying if the prospective provider is an unregistered authorized provider of the given item.

Preferably, the authentication data comprises an indication of an unsuccessful authentication if the given item is stolen, counterfeited or if the prospective provider is not an authorized provider of the given item, and an indication of a successful authentication if otherwise.

The input/output unit is preferably adapted to be connected to a data network for receiving the authentication data, where the data network comprises at least one of the Internet and a mobile phone network.

Preferably the authentication data is a result of an authentication process comprising transmitting an authentication request for inquiring an authentication database comprising, for each one of a plurality of items, an identifier for uniquely identifying the item and at least one corresponding authorized item provider, the authentication request comprising an identification of the given item and an identification of the prospective provider, the method further comprising providing an indication of a successful authentication if the identification of the given item and the identification of the prospective provider are comprised in the authentication database, otherwise providing an indication of an unsuccessful authentication.

As a further aspect of the invention, there is provided a system for controlling listing of a given item on an electronic market database, the system comprising:
an authentication database;
an authentication unit connected to the authentication database for authenticating at least one of the given item and of a prospective provider of the given item, and for generating an authentication signal as a function of the authenticating; and
a listing module connected to the authentication unit for listing the given item on the electronic database if an indication of a successful authentication is received from the authentication unit.

Preferably, the authentication database comprises, for each one of a plurality of items, an identifier for uniquely identifying the item and at least one corresponding authorized item provider, and the authenticating comprises transmitting an authentication request to the authentication database comprising an identification of the given item and an identification of the prospective provider and receiving an authentication response therefrom comprising an indication if the identification of the given item and the identification of the prospective provider are comprised in the authentication database.

Preferably, the system further comprises a listing request receiving module connected to the authentication unit and adapted to be connected to a data network for receiving a listing request for listing the given item on the electronic database, the listing request comprising the identification of the given item and an identification of the prospective provider.

Preferably, the system further comprises an inquiring unit connected to the authentication unit and to the listing module for communicating, if required, with a third party trusted source for verifying if the prospective provider is an unregistered authorized provider of the given item, and for transmitting an indication of a successful authentication to the listing module if a positive confirmation is received thereof.

Preferably, the inquiring unit is connected to a user interface adapted to be connected to a data network for allowing a given user to manually trigger the inquiring process using the data network.

Preferably, the system is adapted to be connected to a data network.

Preferably, the system is principally provided by a mediator using a mediator server connected to the data network.

As a further aspect of the invention, there is provided a method for authenticating a prospective provider of a given item, the method comprising:
accessing a database comprising for each of a plurality of items, an identifier for uniquely identifying the item and at least one corresponding authorized item provider, with an indication of the given item and an identification of the prospective provider; and
if the indication of the given item and the identification of the prospective provider are comprised in the database, providing an indication of a successful authentication.

### BRIEF DESCRIPTION OF THE DRAWINGS

Further features and advantages of the present invention will become apparent from the following detailed description, taken in combination with the appended drawings, in which:

FIG. 1 is a diagram which shows how various users may access a system for authenticating a prospective provider (ex. authorized seller or owner) of a given item according to an embodiment;

FIG. 2 is a diagram which shows one embodiment for accessing the system for authenticating a prospective provider (ex. authorized seller or owner) a given item according to an embodiment; and

FIG. 3 is a flowchart which shows an embodiment of a method for authenticating a prospective provider (ex. authorized seller or owner)) of a given item according to an embodiment.

FIG. 4 is a flowchart which shows an embodiment of a method for controlling listing of an item on an electronic market database;

FIG. 5 is a flowchart which shows a second embodiment of a method for controlling listing of an item on an electronic market database;

FIG. 6 is a diagram which shows an embodiment of a system for controlling listing of an item on an electronic market database;

FIG. 7 is a diagram which shows an embodiment of a unit for controlling listing of an item on an electronic market database;

It will be noted that throughout the appended drawings, like features are identified by like reference numerals.

### Description of the Preferred Embodiments

### Authentication of Prospective Providers of Items

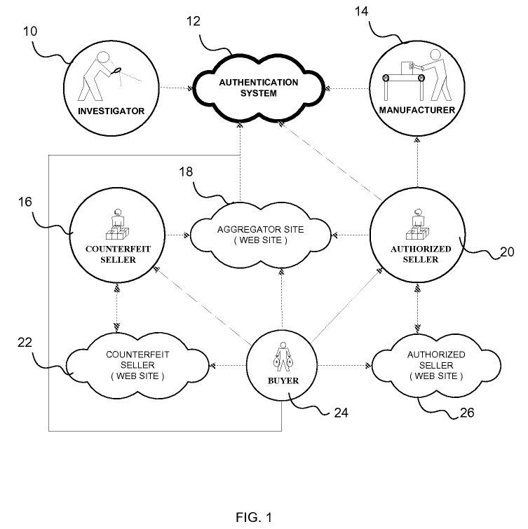

Now referring to FIG. 1, there is shown how various users may access an authentication system 54 for authenticating a prospective provider (ex. authorized seller or owner) of a given item.

In the disclosed embodiment, an aggregator site 18 (i.e. a website) is used to buy and sell items. More precisely, a buyer 24 may access the aggregator site 18, select an item from a plurality of items to sell and buy at least one selected items on the aggregator site 18.

It will be appreciated that the items to be sold on the aggregator site 18 may be either authorized (i.e. legitimate items) or unauthorized (such as for instance counterfeit items or “grey market items”). More precisely, authorized items are provided by an authorized seller 20 who posts a list of a plurality of authorized items to sell on the aggregator site 18. On the other hand, counterfeit items may be posted on the aggregator site 18 by a counterfeit item seller 16.

It will be appreciated that the counterfeit item seller 16 may also directly or indirectly operate a website 22 or a shop (not shown in the figures) comprising exclusively, or not exclusively, counterfeit items. Similarly, the authorized item seller 20 may also directly or indirectly operate a website 26 or a shop (not shown in the figures) comprising exclusively, or not exclusively, authorized items.

The authorized seller usually receives the authorized items from a manufacturer 14.

The skilled addressee will appreciate that the buyer 24 has the difficult task of choosing a reliable place in order to buy authorized items.

In the embodiment disclosed in FIG. 1, an authentication system 12 is operatively coupled to the aggregator 18. The authentication system 12 is used to authenticate a prospective provider (ex. authorized seller or owner) for a given item. The authentication system 12 is therefore used to provide an indication that a prospective provider is authorized to provide a given item. In the embodiment disclosed in FIG. 1, the authorized system 12 operates as an application.

More precisely, the manufacturer 14 provides the authentication system 12 with an identifier for uniquely identifying each item and an identification of at least one corresponding authorized seller who is authorized to sell the corresponding item. It will be appreciated that the identifier for uniquely identifying each item comprises for instance an item serial number, an SKU (Stock Keeping Unit), a Universal Product Code (UPC), a European Article Number (EAN), a Global Trade Item Number (GTIN) or the like. The identification of the at least one corresponding authorized seller who is authorized to sell the corresponding item comprises for instance a seller reference, a seller zip code or the like.

When the buyer 24 accesses the aggregator site 18, the buyer may request that an authentication check be performed in order to validate that the item is an authorized item.

Since the items may have been posted by an authorized item seller 20 and a counterfeit item seller 16, an authentication check is required (for example, before listing the item). In one embodiment, the authentication check is performed by the aggregator site 18 using the authentication system 12.

In one embodiment, the aggregator site 18 provides to the authentication system 12 a request for authentication comprising an identifier for the item to check and an identification of its corresponding seller. In response, the aggregator site 18 receives from the authentication system a response indicative that the item is genuine or not.

The buyer may therefore be able to buy in confidence the item. It will be appreciated that the request for authentication may be performed according to various embodiments. For instance, the request for authentication may be performed each time an item is posted on the aggregator site 18. Alternatively, the request for authentication may be performed each time a prospective buyer desires to authenticate a given item.

Alternatively, the buyer 24 may desire to contact directly the authentication system 12 in order to perform the authentication check.

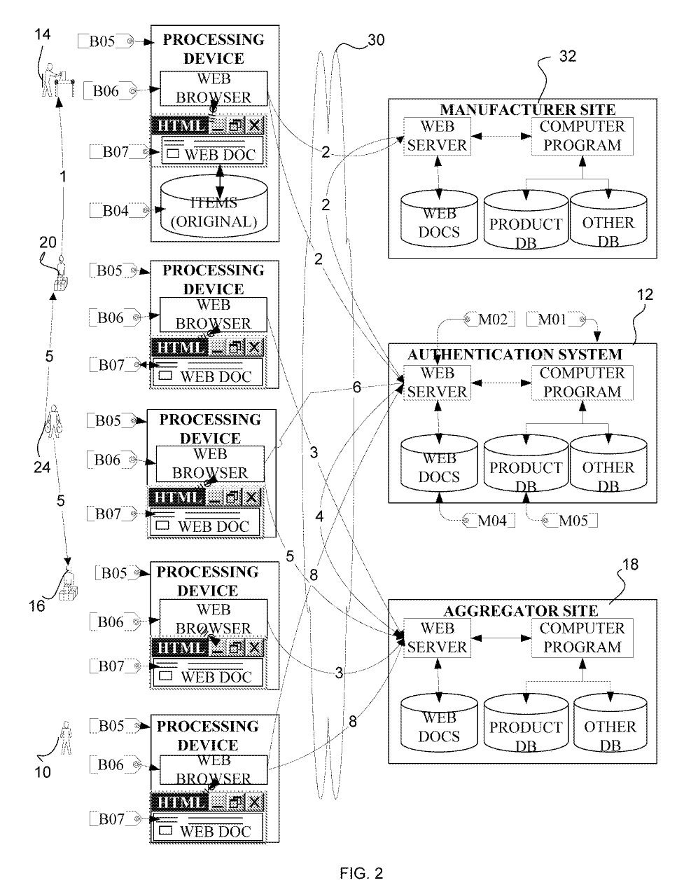

Now referring to FIG. 2, there is shown how each of the manufacturer 14, the authorized seller 20, the buyer 24, the counterfeit item seller 16 and the investigator 10 communicates with the authentication system 12, the aggregator site 18 and the manufacturer site 32.

It will be appreciated that each of the manufacturer 14, the authorized seller 20, the buyer 24, the counterfeit item seller 16 and the investigator 10 communicates using a corresponding processing device. Each corresponding processing device is operatively connected to a data network 30.

Each of the authentication system 12, the aggregator site 18 and the manufacturer site 32 is operatively connected to the data network 30.

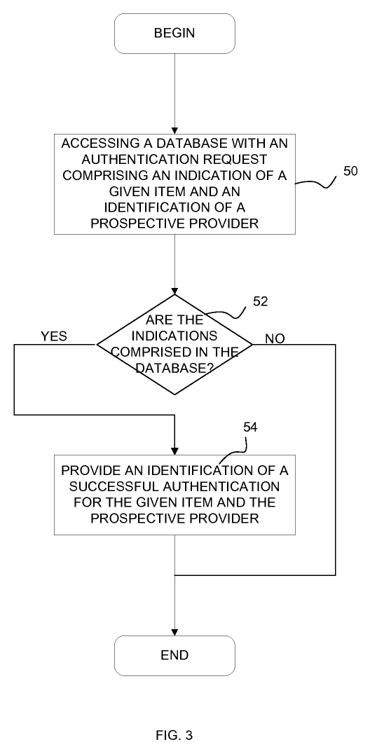

Now referring to FIG. 3, there is shown an embodiment for authenticating a prospective item provider (ex. authorized seller or owner) of a given item according to one embodiment.

According to step 50, a database is accessed with an authentication request. In one embodiment, the database is accessed with an authentication request comprising an indication of a given item and an identification of a prospective provider. In one embodiment the authentication request is provided by the aggregator site. Alternatively, the authentication request is provided directly by a buyer. Alternatively, the authentication request is provided by an investigator investigating the given item provided by a prospective provider under investigation.

According to step 52, an authentication check is performed in the accessed database in order to find out if the combination of the indication of a given item and the identification of a prospective provider is located in the database.

In the case where the combination of the indication of a given item and the identification of a prospective provider is located in the database and according to step 54, an identification of a successful authentication for the given item and the prospective provider is provided. It will be appreciated by the skilled addressee that the identification of a successful authentication for the given item and the prospective provider may be provided according to various embodiments. The provision of the identification of a successful authentication for the given item may comprise the provision of sales history, manufacturer information, manufacturing date or the like. The amount of information provided may depend on the type of individual performing the request.

Following the provision of the indication, various situations may ensue. For instance, in an embodiment, the indication may be used to certify the item on the aggregator site via a logo or an emblem displayed. Alternatively, the indication may be used by a user to assess the legitimacy of the item. Alternatively, the indication may be used by an investigator to assess the legitimacy of the item and the prospective provider. The indication may also be used to reject the posting of an item of the aggregator site.

It will be appreciated that the authentication system may be operatively connected to any item providers to provide a certification to potential buyers. The authentication system may be used to locate grey market reseller or stolen item reseller.

It will be further appreciated that a buyer may then register himself as a provider following the purchase of the item. The will maintain a chain of title and also guarantee the authenticity of the item sales after sales and enable future authentication checks.

It will further be appreciated that other various information may be provided for each item such as a description of the item, a picture of the item. The name, address and zip code of each manufacturer may also be provided.

Furthermore, an indication of online as well as offline item providers may be provided.

It will be appreciated that an authorized item provider may use the authentication system to report that previously registered items were stolen or lost. Thus, when a counterfeit item seller tries to sell the stolen or lost item, the authentication system will deny authorization (after proper verification as described herein). An investigator may also be advised and asked to launch an investigation to retrace the holder of the lost or stolen item.

For items which are already on the market (sold prior to the operation of an authentication system such as described herein), it is possible (and useful in case of later resale) for the owner of the item to register the product as authentic. With proper paperwork, the owner will make an appropriate request to the manufacturer or other authorized party to have the item registered in the authentication system's database.

When a buyer/owner purchases a product, the item registration process may be automated. For example, the information from the transaction can be sent directly from the item seller or manufacturer to the aggregator site, which can then send it to the authentication system. The authorization of the owner can also be requested to approve the item information.

The authentication system allows manufacturers to control the flow of new goods through authorized distribution channels by identifying regions/countries where specific items can be sold, as part of registered item information. Thus, if a provider is trying to sell an item to buyers located in areas other than those authorized or intended by the manufacturer, an investigator can use the authentication system to identify these items/providers. An operator of an aggregator site can also request that the authentication system to deny/reject/identify listings of such items on its site.

### Controlling Listing of Items on Electronic Market Databases

The present embodiment of the invention illustrates a method, a system and a unit for controlling listing of items on electronic market databases.

The present embodiment of the invention will be illustrated with respect to an item controller having a server connected to an electronic market database using a data network (ex. the Internet), where the electronic market database contains a list of items offered for trade by participants over the data network. The electronic market database can for instance be administrated by the controller himself or by a third party for which the controller has the mandate to control the listing of items on his electronic market database.

It should be understood by those skilled in the art that the present embodiment of the invention could be incorporated outside the frame of a mediator having an electronic market database. For instance, the present invention can be performed by a person having a Web site and desiring to control the listing of his personal items on his personal Web site. The reason of such a practice can be on a voluntary basis or on a mandatory basis if it happens that governmental authorities decide to adopt such rules in order to control the e-commerce trade of counterfeited and stolen items.

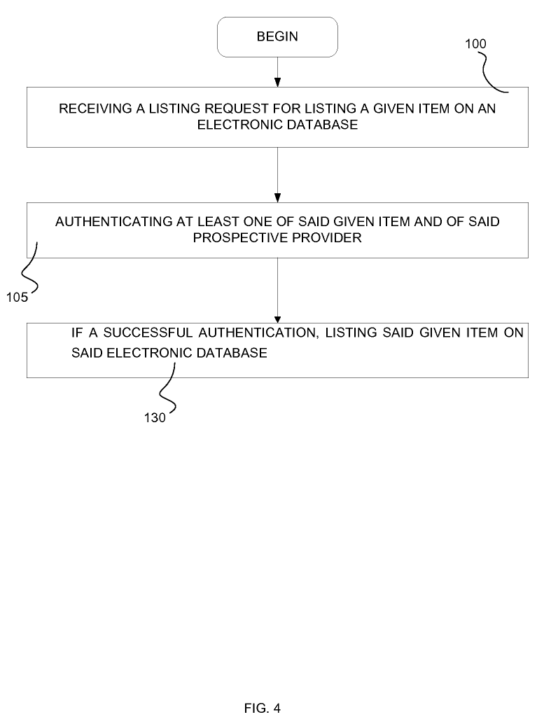

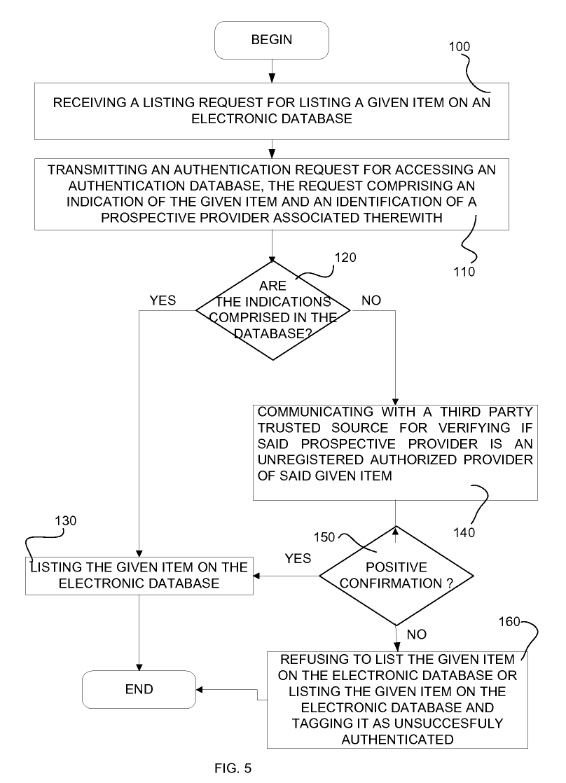

Referring to FIG. 4 and FIG. 5, there is provided a method for controlling listing of a given item on an electronic market database. First, the controller receives a listing request for listing a given item on an electronic market database 100. Once the listing request is received by the controller, the latter authenticates at least one of the given item and the prospective provider 105. The authentication process consists of verifying if the given item is stolen, counterfeited or provided for trade by an unauthorized item provider.

The authentication process is preferably carried out by accessing and inquiring an authentication database 370 comprising, for each one of a plurality of items, an identifier for uniquely identifying the item and at least one corresponding authorized item provider, where the inquiring comprises transmitting an authentication request 110 to the authentication database 370 comprising an identification of the given item and an identification of the prospective provider of the given item, and receiving an authentication response therefrom with an indication of a successful authentication if the identification of the given item and the identification of the prospective provider are comprised in the authentication database 120.

It should be understood that the given item to list could consist of an individual item having an identifier or a group of items that are identified conjointly with a same identifier.

In this case, preferably, the listing request comprises the identification of the given item and an identification of the prospective provider desiring to list the given item for trade, but this information can also be obtained automatically by the controller, for instance if this information is accessible via the data network.

The identification of the given item consists of an identifier for uniquely identifying the given item, such as a serial number.

Due to its efficiency, the authentication process described hereinabove is provided according to the preferred embodiment, however it should be understood by those skilled in the art that the authentication process can be carried out in various manners.

Moreover, the authentication database is preferably structured according to the authentication database described hereinabove 370, however it should be understood by those skilled in the art that authentication databases differently structured could also be used, such as manufacturers' databases comprising an identification of counterfeited or stolen items or authorized providers of items manufactured thereby. In this case, the controller would have knowledge of the manufacturer of the given item to list, accesses and inquires the appropriate manufacturer database among a group of accessible manufacturer databases rendered accessible through the data network.

Once the authentication process is carried out, the controller lists the given item on the electronic market database 130.

In case of an unsuccessful authentication, knowing in case where the identification of the given item and the identification of the prospective provider are not comprised in the authentication database 370, the controller can reject the listing request and refuses to list the given item on the electronic database. The controller can also tag the item as unsuccessful authenticated and list the tagged item. In this case, the controller exonerates his responsibility by acknowledging the public that the given item is unsuccessful authenticated and leaves them the choice to purchase or not the given item.

In the case of an unsuccessful authentication, the controller can also communicate with a third party trusted source for verifying if the prospective provider is an unregistered authorized provider of the given item 140, and lists the given item on the electronic database if a positive confirmation is received thereof 130 and 150, otherwise refusing to list the given item or tagging the given item as unsuccessfully authenticated and listing the tagged item 160.

The third party trusted source could be an investigator. In this case, the controller transmits an inquiring request to the investigator with an indication of the given item and of the prospective provider. The investigator verifies the authenticity of the prospective provider and transmits an inquiring response to the controller with a positive confirmation if the authenticity is confirmed. In this case, the controller stores a list of investigators with appropriate information in connection therewith in order to communicate with them in case of need.

The third party trusted source could also be an authorized item provider registered in the authentication database in association with the given item. In this case, the controller transmits an inquiring request to the registered authorized provider with an indication of the given item and of the prospective provider, and lists the given item on the electronic database if a positive confirmation is received thereof, otherwise refusing to list the given item. The information about the registered authorized provider is extracted from the authentication database 370.

The inquiring request could be triggered manually by a user, such as the prospective provider himself or the investigator, or automatically by the controller upon reception of an unsuccessful authentication from the authentication database.

The objective of this process of verification with the third party trusted source is to verify whether that the prospective provider is an authorized provider of the item even if he is unregistered in the authentication database. This situation could arise, for instance, if an ownership transfer from the registered authorized item provider (the one registered in the authentication database) to the prospective provider has been carried out in association with the given item ulterior to the registration of the item in association with the registered prospective provider in the authentication database.

Another example where this situation could arise is if the prospective provider is an authorized mandatary (ex. to list or to sell the item) of the registered authorized provider.

If a positive confirmation is received from the third party trusted source, the authentication database could be updated to add the prospective provider an authorized provider of the given item.

The authentication database as construed can be of a big utility for various users, such as manufacturers, advertisers, marketers, insurance companies and investigators.

For instance, the insurance companies can use the authentication database for insurance purposes. They can report stolen items of their clients, and can provide an insurance discount for their clients if the item to be insured has been previously registered in the authentication database. Marketers could access the authentication database to profile users using their owned items per geolocalization, type of items, etc. Investigators could access the authentication database to verify ownership status (owner identity hidden) and authenticity of products. Advertisers could place ads to be displayed to users searching/browsing items on the authentication database. Manufacturers could register newly realized items to be protected against counterfeiting, black market, and grey market.

The communications between the controller and the authentication database could be performed through any medium of communication, for instance, through the Internet, SMS, telephone or mobile phone, or paper documents.

In the preferred embodiment, the method is principally carried out by a mediator using a mediator server connected to a data network comprising at least one of the Internet and a mobile phone network.

In this case, the electronic market database can be locally connected to the mediator server or remotely connected thereto through the data network. Furthermore, the authentication database can be locally connected to the mediator server or remotely connected thereto through the data network.

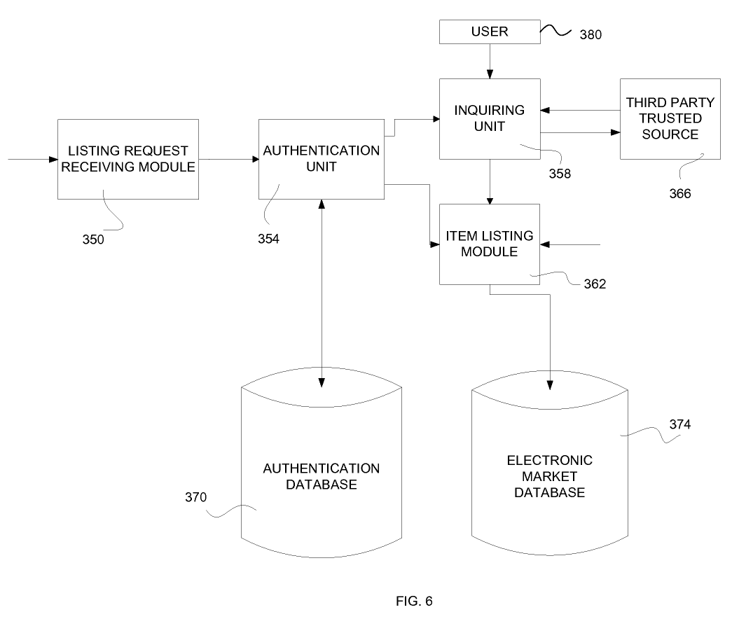

Referring to FIG. 6, there is provided a system for controlling listing of a given item on an electronic market database.

At the basic level, the system comprises an authentication database 370, an authentication unit 354 connected to the authentication database 70 for authenticating at least one of the given item and of the prospective provider, and for generating an authentication signal as a function of the authenticating; and a listing module 362 connected to the authentication unit for listing the given item on the electronic database if an indication of a successful authentication is received from the authentication unit 54.

As described hereinabove, according to the preferred embodiment, the authentication database 370 comprises, for each one of a plurality of items, an identifier for uniquely identifying the item and at least one corresponding authorized item provider.

In this case, the authenticating process comprises transmitting an authentication request to the authentication database 70 comprising an identification of the given item and an identification of the prospective provider and receiving an authentication response therefrom comprising an indication if the identification of the given item and the identification of the prospective provider are comprised in the authentication database 370.

According to the preferred embodiment, the system further comprises a listing request receiving module 350 connected to the authentication unit 354 and adapted to be connected to a data network for receiving a listing request originated from the prospective provider for listing the given item on the electronic market database 374. In the preferred embodiment, the listing request comprises the identification of the given item and an identification of the prospective provider. In another embodiment, the controller collects automatically this information from a database accessible through the data network.

According to another embodiment of the present invention, the controller authenticates a given item to list without having received a listing request originated from the prospective provider of that item. This situation can occur for instance when the item has already been listed on an electronic market database before the implementation of the present invention and the controller desires to control a posteriori the listing of the items. Thus, the controller authenticates the item without a prior request from the provider thereof and then takes a listing decision according to the present invention. According to this embodiment, the incorporation of listing request receiving module 50 in the system is not necessary.

According to the preferred embodiment, the system further comprises an inquiring unit 358 connected to the authentication unit 354 and to the listing module 362 for communicating, if required, with a third party trusted source for verifying if the prospective provider is an unregistered authorized provider of the given item, and for transmitting an indication of a successful authentication to the listing module 362 if a positive confirmation is received thereof. If a negative response is received, the controller can decide to refuse to list the given item or to tag the given item as unsuccessfully authenticated and to list the tagged item.

According to the preferred embodiment, the inquiring unit 358 is connected to a user interface adapted to be connected to a data network for allowing a given user to manually trigger the inquiring process using the data network. The inquiring process can also be triggered automatically by the inquiring unit 358 upon reception thereof an indication of an unsuccessful authentication from the authentication unit 354. As illustrated hereinabove, this given user can be an investigator, the prospective provider himself or any other convenient user.

According to the preferred embodiment, the system is principally provided by a mediator using a mediator server connected to a data network, and the electronic market database 374 is locally connected to the mediator server or remotely connected thereto using the data network.

Furthermore, as illustrated hereinabove, the authentication database can be locally connected to the mediator server or remotely connected thereto through the data network. Preferably, the system data network comprises at least one of the Internet and a mobile phone network.

The communications between the mediator and the different entities could be performed through any medium of communication, for instance, through the Internet, SMS, telephone or mobile phone, or paper documents.

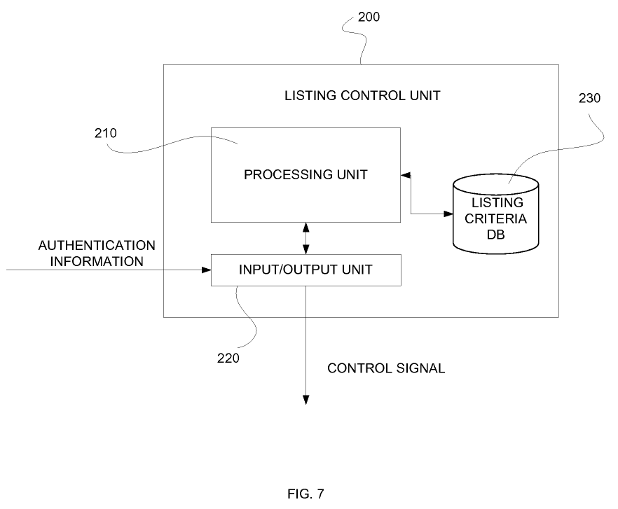

Referring to FIG. 7, there is provided a unit 200 for controlling listing of a given item on an electronic market database, the unit comprising an input/output unit 220, a processing unit 210 and a listing criteria database 230, where the input/output unit 220 receives authentication data in connection with at least one of the given item and of a prospective provider of the given item and transmits the authentication data to the processing unit 210, where the processing unit processes the authentication data as a function of defined listing criteria stored in the listing criteria database 230 and generates a control signal as a function of the processing.

According to the preferred embodiment, the control signal is selected from the group consisting of an indication to allow listing the given item, an indication to refuse listing the given item, an indication to tag the given item as unsuccessfully authenticating and to allow listing the tagged item, and an indication to communicate with a third party trusted source for verifying if the prospective provider is an unregistered authorized provider of the given item.

As described more in detail hereinabove, the authentication data comprises an indication of an unsuccessful authentication if the given item is stolen, counterfeited or if the prospective provider is not an authorized provider of the given item, and an indication of a successful authentication if otherwise.

According to the preferred embodiment, this process of authentication is carried out by accessing and inquiring an authentication database 370 as described more in detail hereinabove.

According to the preferred embodiment, the listing criteria comprises accepting to list the given item if a successful authentication, and if otherwise either refusing to list the given item, tagging the given item and accepting to list the tagged item or communicating with a third party trusted source for a verifying if the prospective provider is an authorized provider of the given item. The listing criteria database can also comprise an identification of the third party trusted source to communicate with, such as an investigator.

The input/output unit is adapted to be connected to a data network for receiving the authentication data, where the data network comprises at least one of the Internet and a mobile phone network.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiment(s) of the invention described above is (are) intended to be exemplary only. The scope of the invention is therefore intended to be limited solely by the scope of the appended claims.

1. A method for controlling listing of a given item on an electronic market database, the method comprising:
receiving a listing request originated from a prospective provider for listing said given item on said electronic market database;
authenticating at least one of said given item and of said prospective provider; and
if a successful authentication, listing said given item on said electronic database.

2. The method as claimed in claim 1, wherein said authenticating said given item comprises verifying if said given item is counterfeited or stolen and said authenticating said prospective provider comprises verifying if said prospective provider is an authorized provider of said given item.

3. The method as claimed in claim 2, wherein said authenticating comprises transmitting an authentication request for inquiring an authentication database comprising, for each one of a plurality of items, an identifier for uniquely identifying said item and at least one corresponding authorized item provider, said authentication request comprising an identification of said given item and an identification of said prospective provider, said method further comprising providing an indication of a successful authentication if said identification of said given item and said identification of said prospective provider are comprised in said authentication database, otherwise providing an indication of an unsuccessful authentication.

4. The method as claimed in claim 3 further comprising, if said given item is listed on said electronic database and eventually purchased by a new party, automatically updating said authentication database to reflect an ownership transfer from said prospective provider to said new party.

5. The method as claimed in claim 3, further comprising, if an unsuccessful authentication, refusing to list said given item on said electronic database.

6. The method as claimed in claim 3, further comprising, if an unsuccessful authentication, tagging said given item as unsuccessfully authenticated and listing said tagged given item on said electronic database.

7. The method as claimed in claim 3, further comprising, if an unsuccessful authentication, communicating with a third party trusted source for verifying if said prospective provider is an unregistered authorized provider of said given item, and listing said given item on said electronic database if a positive confirmation is received thereof.

8. The method as claimed in claim 7 wherein said third party trusted source is an investigator, and said communicating comprises transmitting an inquiring request to said investigator with an indication of said given item and of said prospective provider.

9. The method as claimed in claim 8, wherein said inquiring request transmitted to said investigator is triggered manually by a user or automatically upon reception of an unsuccessful authentication.

10. The method as claimed in claim 7 wherein said third party trusted source is an authorized item provider registered in said authentication database in association with said given item, and said communicating comprises transmitting an inquiring request to said registered authorized provider with an indication of said given item and of said prospective provider.

11. The method as claimed in claim 10, wherein said inquiring request transmitted to said registered authorized item provider is triggered manually by a user or automatically upon reception of an unsuccessful authentication.

12. The method as claimed in claim 10, wherein said verifying if said prospective provider is an unregistered authorized provider of said given item consists of verifying if an ownership transfer from said registered authorized item provider to said prospective provider has been carried out in association with said given items.

13. The method as claimed in claim 12, further comprising updating said authentication database to reflect said ownership transfer if a positive confirmation is received.

14. The method as claimed in claim 3 wherein said communication with said authentication database is performed through the Internet, SMS, telephone or mobile phone, or paper documents.

15. The method as claimed in claim 3, wherein said method is principally carried out over a data network.

16. The method as claimed in claim 15, wherein said data network comprises at least one of the Internet and a mobile phone network.

17. The method as claimed in claim 16, wherein said method is principally carried out by a mediator using a mediator server connected to said data network.

18. The method as claimed in claim 17, wherein said electronic market database is locally connected to said mediator server or remotely connected to said mediator server through said data network.

19. A unit for controlling listing of a given item on an electronic market database, the unit comprising an input/output unit, a processing unit and a listing criteria database, where said input/output unit receives authentication data in connection with at least one of said given item and of a prospective provider of said given item and transmits said authentication data to said processing unit, where said processing unit processes said authentication data as a function of defined listing criteria stored in said listing criteria database and generates a control signal as a function of said processing.

20. The unit as claimed in claim 19, wherein said control signal is selected from the group consisting of an indication to allow listing said given item, an indication to refuse listing said given item, an indication to tag said given item as unsuccessfully authenticating and to allow listing said tagged item, and an indication to communicate with a third party trusted source for verifying if said prospective provider is an unregistered authorized provider of said given item.

21. The unit as claimed in claim 20, wherein said authentication data comprises an indication of an unsuccessful authentication if said given item is stolen, counterfeited or if said prospective provider is not an authorized provider of said given item, and an indication of a successful authentication if otherwise.

22. The unit as claimed in claim 21, wherein said input/output unit is adapted to be connected to a data network for receiving said authentication data, where said data network comprises at least one of the Internet and a mobile phone network.

23. A system for controlling listing of a given item on an electronic market database, the system comprising:
an authentication database;
an authentication unit connected to said authentication database for authenticating at least one of said given item and of a prospective provider of said given item, and for generating an authentication signal as a function of said authenticating; and
a listing module connected to said authentication unit for listing said given item on said electronic database if an indication of a successful authentication is received from said authentication unit.

24. The system as claimed in claim 23, wherein said authentication database comprises, for each one of a plurality of items, an identifier for uniquely identifying said item and at least one corresponding authorized item provider, and said authenticating comprises transmitting an authentication request to said authentication database comprising an identification of said given item and an identification of said prospective provider and receiving an authentication response therefrom comprising an indication if said identification of said given item and said identification of said prospective provider are comprised in said authentication database.

25. The system as claimed in claim 24 further comprising a listing request receiving module connected to said authentication unit and adapted to be connected to a data network for receiving a listing request for listing said given item on said electronic database, said listing request comprising said identification of said given item and an identification of said prospective provider.

26. The system as claimed in claim 24 further comprising an inquiring unit connected to said authentication unit and to said listing module for communicating, if required, with a third party trusted source for verifying if said prospective provider is an unregistered authorized provider of said given item, and for transmitting an indication of a successful authentication to said listing module if a positive confirmation is received thereof.

27. The system as claimed in claim 26 wherein said inquiring unit is connected to a user interface adapted to be connected to a data network for allowing a given user to manually trigger said inquiring process using said data network.

28. The system as claimed in claim 24, wherein said system is adapted to be connected to a data network.

29. The system as claimed in claim 28, wherein said system is principally provided by a mediator using a mediator server connected to said data network.

30. The system as claimed in claim 29, wherein said electronic market database is locally connected to said mediator server or remotely connected thereto using said data network.

31. The system as claimed in claim 30 wherein said data network comprises at least one of the Internet and a mobile phone network.

32. A method for authenticating a prospective provider of a given item, the method comprising:
accessing a database comprising for each of a plurality of items, an identifier for uniquely identifying said item and at least one corresponding authorized item provider, with an indication of said given item and an identification of said prospective provider; and
if said indication of said given item and said identification of said prospective provider are comprised in the database, providing an indication of a successful authentication.
